(19) United States
(12) Patent Application Publication
(10) Pub. No.: US 2007/0018458 A1
(43) Pub. Date: Jan. 25, 2007

(54) Method and apparatus for wave energy conversion using a floating pulley and counterweight

(76) Inventor: Melaquias Eugene Martinez, Bolyston, MA (US)

Correspondence Address: Law Office of Brett N. Dorny;Suite 12A, 386 West Main Street, Northborough, MA, 01532, US

(21) Appl. No.: 11/435,700

(22) Filed: May 17, 2006

Related U.S. Application Data
(63) Continuation-in-part of application No. 11/187,112, filed on Jul. 22, 2005, now abandoned.

(51) Int. Cl. F03B 13/12; F03B 13/10; H02P 9/04

(52) U.S. Cl. 290/53

(57) ABSTRACT

A wave energy conversion system includes a tether connected to the ocean floor or to an anchor weight at one end and a counterweight at the other. The tether passes over a pulley connected to a float. As the float moves up and down due to wave motion, the counterweight is raised and lowered and the tether rotates the pulley. An axle of the pulley is connected to a power conversion system for creating usable energy from the rotation and a power transmission system for transmitting the usable energy to shore. The pulley may be suspended from the float and directly connected to immersion pumps for generating energy. Multiple systems can be used and connected together to provide additional power levels.

### CROSS-REFERENCE TO RELATED APPLICATIONS

This application is a continuation-in-part of U.S. patent application Ser. No. 11/187,112, filed Jul. 22, 2005, which is pending.

### BACKGROUND OF THE INVENTION

1. Field of the Invention

The present invention relates a method and system for extraction of energy from wave and tidal motion in a body of water. More particularly, it relates to a system and method for extracting energy from wave motion using a float.

2. Discussion of Related Art

The naturally occurring wave action in the ocean represents a potentially immense source of energy if it can be extracted economically. A large variety of systems have been created to extract energy from waves. Such systems include floats, pistons, pumps, and shafts. Some rely upon waves with short periodicity. Others require longer periods.

Many known energy conversion systems reside deep underwater and consist of large and complex assemblies. These assemblies often require unique apparatus which are difficult to construct. Because of the ocean conditions, specialized equipment and labor skilled in underwater construction are required for construction and maintenance of such apparatus. Correction of simple problems requires significant effort. Additionally, to avoid the high repair and maintenance costs, the parts specifications and tolerances in construction are very exact. Thus, the costs associated with construction and maintenance are high.

A limited dynamic operating range is a problem with many existing systems. These systems only provide power or are efficient for wave amplitudes and periods falling within limited ranges. In particular, when waves are large, such as from storm surges, many of the schemes reach the limit of their operating range, cutoff energy conversion, fail altogether or are unable to utilize the excess energy. Other systems are limited in that they can only extract energy from waves motion in one direction.

Additionally, a major concern with many wave and tidal energy conversion schemes is their environmental impact. The environmental impacts that related art pose vary from destruction of ocean bottom environments for construction of apparatus to interference with sea life moving through the ocean by underwater turbines, ‘windmills’ and tidal dams. In addition, in shallower waters, extensive lateral profiles of elevated or floating structures present problems due to shading of the sun.

### SUMMARY OF THE INVENTION

The present invention avoids many of the problems of existing systems through the use of a simple energy conversion system using counterweights coupled to a pulley. The pulley is supported on a float which remains on top of the water, with the counterweights hanging in the water. According to an aspect of the invention, the counterweights are sized such that one is significantly larger so that as the float moves the lighter weight is raised and lowered. The weights are coupled to the pulley with a cable so that as the lighter weight moves, the pulley is rotated. According to another aspect of the invention, one end of the cable is anchored to the ocean floor instead of to a heavier weight.

According to another aspect of the invention, the weights are connected together by a tether which is looped over the pulley to provide the coupling. According to another aspect of the invention, a shaft of the pulley is connected to a power conversion system to extract energy from the system. The power conversion system may be a pump or an electrical generator or mechanical drive train. According to another aspect of the invention, an energy collection system is connected to the power conversion system to transfer the extracted energy to a location where it can be used.

According to another aspect of the invention, a plurality of similar systems are deployed over a portion of the water. An energy collection system receives and combines the energy converted by each of the systems.

### BRIEF DESCRIPTION OF THE DRAWINGS

FIG. 1 illustrates a wave energy conversion system according to an embodiment of the invention from a first direction.

FIG. 2 illustrates the wave conversion system of FIG. 1 from a second direction, substantially perpendicular to the first direction.

FIG. 3 illustrates a second embodiment of the invention.

FIG. 4 illustrates a wave energy conversion system according to a third embodiment of the invention from a first direction.

FIG. 5 illustrates additional details of the wave energy conversion system of FIG. 4 from a second direction substantially perpendicular to the first direction.

FIG. 6 illustrates a plurality of wave conversion systems according to an embodiment of the present invention.

FIG. 7 illustrates fluid flow through a turbine according to an embodiment of the present invention.

### DETAILED DESCRIPTION

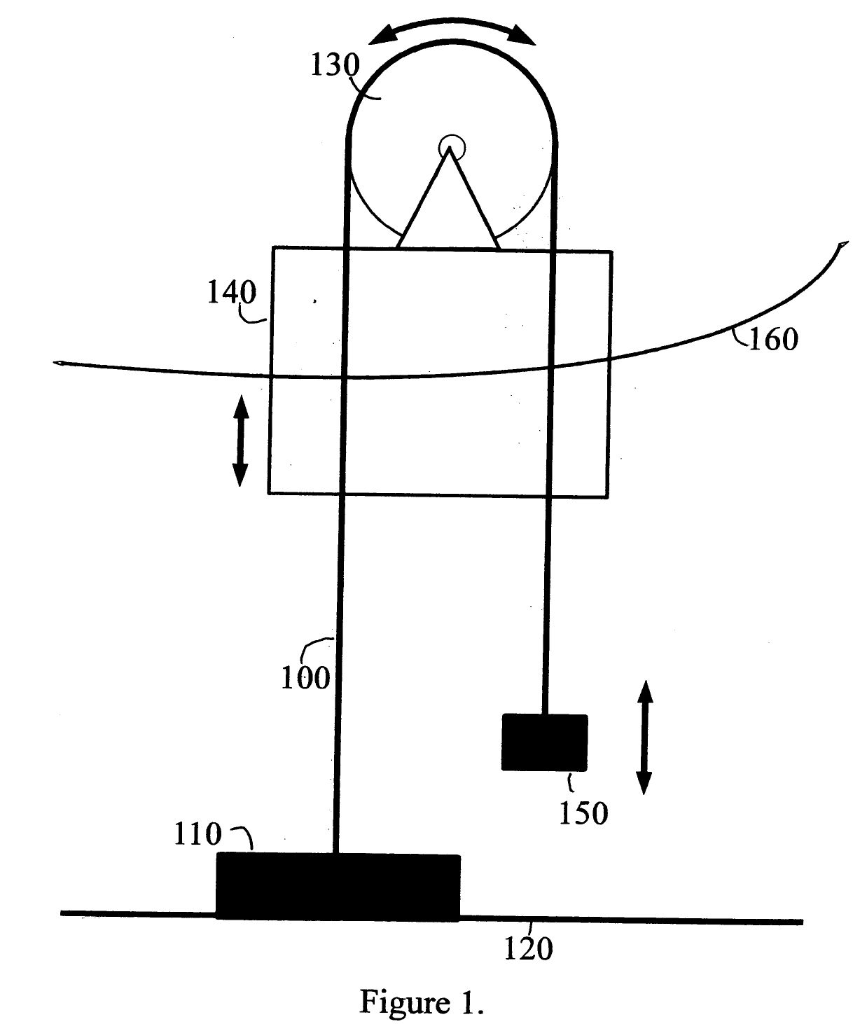

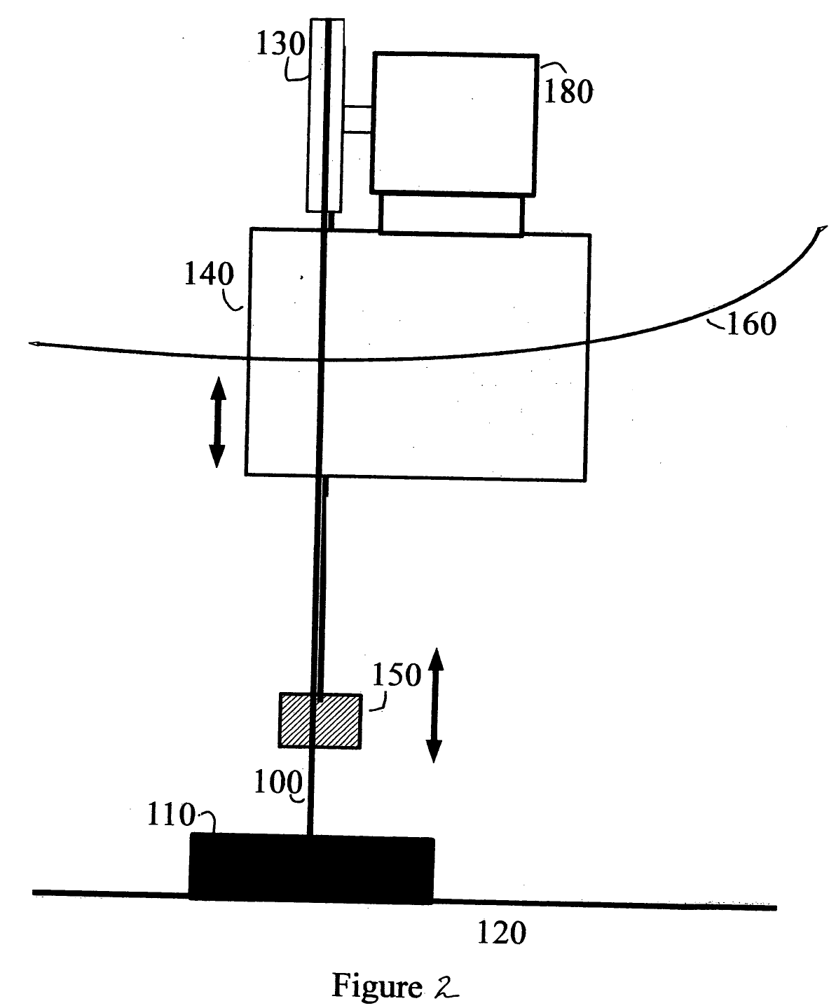

As illustrated in FIGS. 1 and 2, a wave energy extraction system 1 includes a plurality of weights 110, 150 connected to a tether 100. The tether 100 may be composed of any flexible material or combination of fixed and flexible materials, such as rope, chain, cable, etc. The tether 100 passes over a pulley system 130 attached to a float 140. The weights 110, 150 are sized so that one 110 is substantially heavier than the other 150. The heavier weight 110 will rest upon the ocean floor 120. Alternatively, one end of the tether 100 can be attached or anchored to the ocean floor 120 or the weight 110 can be anchored to the ocean floor 120. If a weight 110 is used, it should be heavy enough to remain in a fixed location irrespective of the energy, from waves or wind, against the float 140. As the surface of the water 160 rises, due to wave or tide action, the float 140 rises. As the float 140 rises, the tether 100 is drawn over the pulley towards the fixed or anchored weight 110 and the counterweight 150 rises. As the surface of the water falls, when the wave passes, the float 140 falls and the counterweight 150 is lowered. This moves the tether 100 in the direction of the counterweight 150.

As the tether 100 moves, it passes over the pulley 130 causing it to rotate. The pulley 130 and tether 100 may include teeth or gears (not shown) to improve the coupling between the tether motion and pulley rotation. An axle 131 of the pulley 130 is attached to a power conversion system 180 for converting the rotational power from the pulley to a usable form of energy. Preferably, the power conversion system 180 will provide usable energy when the axle 131 is turned in either direction. In this manner, maximum energy is extracted from the wave 160. Part of the work exerted by the wave on the structure is used to lift the floating structure's weight and the weight of the counterweight. The rest of the work energy available in the wave motion is extractable (net losses due to inefficiencies) through turning of the axle of the pulley. As the surface of the water subsequently lowers, turning the pulley 130 in the opposite direction recovers the energy used to lift the counterweight and makes it extractable.

In an embodiment of the invention, the length of the tether 100 is sized to allow maximum energy extractions independent of the wave conditions. The length of the tether 100 should be short enough such that even when the surface of the water is at its shallowest, for example at lowest tide, and at the swell minimum, the counterweight 150 will not reach the ocean floor 120. Additionally, the length of the tether 100 should be long enough such that at maximum wave heights, for example at high tide and swell maximum, the counterweight 150 will not be lifted all the way to the float 140. In this manner, all wave energy can be extracted. The system 1 should be placed in a location sufficient to accommodate the necessary maximum and minimum tether lengths.

Many types of systems can be used for the power conversion system 180. The pulley axle 131 may be attached through mechanical, hydraulic or other type of power transmission mechanism to any of a variety of systems for converting rotational motion into usable energy or work. Such systems may include a rotors, alternators, and hydraulic pumps. In some embodiments, the system consists of standard, off-the shelf electrical power generation and transmission components. This lowers the cost of constructing and maintaining the system. Standard pumps or other similar systems may also be used.

The float 140 may be composed of any of a variety of buoyant components such as closed-cell foam, containers of air, etc. The buoyant components must provide buoyancy in excess of the weight of the pulley 130, the weight of the buoyant components of the float 140, the power conversion system 180, and the weight of the counterweight 150. The excess buoyancy provides the buoyant force that performs extractable work on the rise of the wave cycle, net losses due to friction and inefficiencies in the power conversion system 180.

Limited underwater construction is necessary for deployment of the system of the present invention. Many times all of the components can be constructed on land or in dry dock and towed to the deployment location. The only underwater activity is attachment of to the ocean floor 120. If an anchor weight 110 is use, no underwater construction may be required. Since the components are disposed on or above the water, they are readily accessible for maintenance.

The tether (100) may consist of any of a variety of materials, including inorganic and/or organic materials and compositions, including monofilament lines, cables, chains, webbing, belts, etc., in both monolythic or composite arrangements. The pulley 130 may be a simple guide wheel, grooved or textured, for improved friction against the tether, or a toothed gear meant to engage links in a chain tether. It is preferable that an embodiment of the tether 100 and pulley 130 be such as to minimize or eliminate slippage at their engagement.

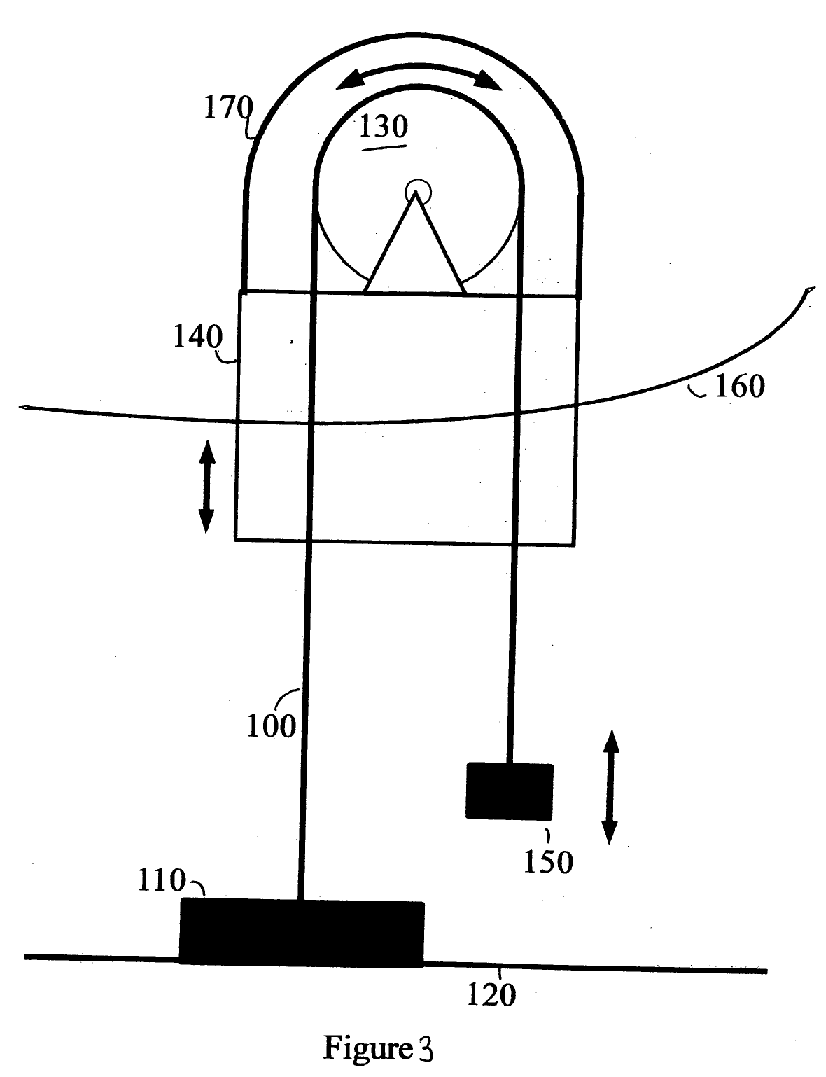

To protect the tether 100, pulley 130 and power conversion system 180 from the environmental conditions, an embodiment of the invention may use a protective cover 170 as depicted in FIG. 3. If sealed tightly, this cover can contribute to the buoyancy of the structure, contributing to the efficiency.

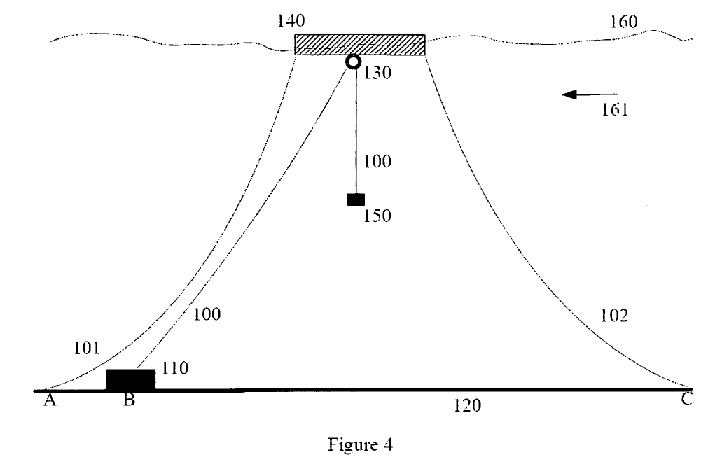

FIG. 4 illustrates a second embodiment of the wave conversion system according to the present invention. In this embodiment, the float 140 is moored to the sea floor 120. Mooring can be accomplished by construction of attachments on the sea floor or through the use of anchor weights (not shown) as discussed above. The weights would need to be of sufficient size and weight such that they remain in position despite wave and wind action on the float 140. Mooring cables 101, 102 are attached to opposite ends of the float 140 and anchor the float 140 to the sea floor 120. Anchoring the float 140 to the sea floor 120 prevents the tether 100 from becoming tangled. It further improves operation of the wave energy conversion system by maintaining the position of the float 120 relative to the anchor weight 110 or anchor point. If the float 140 were to move substantially from its intended position, the freedom of motion of the tether 100 could be adversely affected.

The anchor positions of the tether 100 and mooring cables 101, 102 should be chosen to prevent entanglement of the cables, which could hinder operation of the wave conversion system. As illustrated in FIG. 4, the tether 100 is anchored to the sea floor 120 at point B. the mooring cables 101, 102 are anchored to the sea floor 120 at points A & C, respectively. Points A, B and C are selected relative to the direction of the prevailing current (161) of the local ocean waters. Point B is asymmetrically closer to point A than to point C, but still significantly far from A to prevent entanglement. The anchor points also depend upon the depth of the water and the desired length of the cables. Taking into consideration the depth of the ocean, and accounting for variance due to tide and expected wave heights, and the tendency of heavier-than-water cables to slack in a curve due to their own weight, the fixed lengths of the mooring cables 101, 102 are chosen such that: the upstream mooring cable 102 prevents the float 140 from ever getting close to vertical over point B and the downstream mooring cable 101 prevents the float 140 from ever getting close to vertical over point C.

With this design, the suspended counterweight 150 is always kept at a significant distance from the tether 100 and the mooring cables 101, 102. Spinning of the float 140 is prevented by the two-point mooring and the lateral vector of the tension on the anchor-side of the tether 100. This structure prevents the tether 100, counterweight 150 and mooring cables 101, 102 from becoming tangled.

Use of lighter-than-water cables or a combination of heavier and lighter cables, or the use of strategically placed floats attached to the mooring cables can also help facilitate maintaining a cable geometry that is essentially without risk of entanglement, while still allowing relative free operation of the pulley & tether mechanism. For example, attaching additional cable floats (not shown) to one or both of the mooring cables 101, 102 midway between their anchor points and the float 140 will lift that point of the cable and provide a more horizontal angle of incidence with the float. This may be used on the downstream mooring cable 101 to increase the space between that mooring cable and the tether 100. Consideration for potential interference with boat traffic must, of course, be taken. The angles of approach of any of the cables should not be so horizontal and shallow as to present entanglement risk with boat traffic.

FIG. 4 further illustrates an embodiment of the invention in which the pulley 130 is suspended below the float 140. In the first embodiment, illustrated in FIGS. 1-3, the pulley 130 is mounted on top of the float 140. In such a design, the float must include bore holes to allow the tether to pass through to the pulley 130. The size and position of the bore holes can be problematic. If the float 140 can move significantly in a lateral direction, the angle of the tether 100 can change. The bore hole for the tether 100 must be sized in order to accommodate different angles for the tether 100. In addition to eliminating the need for bore holes, suspending the pulley 130 from the float 140 has other advantages. It enhances the geometric stability of the float assembly. It allows a broad range of angle of incidence for the anchor-side of the tether. Although illustrated with an embodiment having the pulley 130 under the float 140, the mooring system illustrated in FIG. 4 can be used in any embodiment, including one with the pulley 130 mounted on top of the float 140, provided the bore hole(s) provide adequate clearance to accommodate the angles of approach of the tether 100.

With the pulley 130 suspended from float 140, the power conversion system 180 can be placed either above or below the float 140. If the power conversion system 180 is also suspended below the float 140, then it can be directly connected to the pulley 130. For example, an electrical generator may be directly mounted to the pulley axle 131. This requires an electrical generator that is designed and manufactured for immersion under water, specifically sea water, which may add significantly to the cost of the power conversion system 180. This design is also likely to require a rotational multiplier mechanism in order to get sufficient RPMs to drive the generators, which also will add to the cost and maintenance. It also results in generating AC power that may need conversion to DC for long-distance transmission. In some scenarios, this may nevertheless be a preferred configuration. It provides a low profile on top of the float 140 which improves the view above the water.

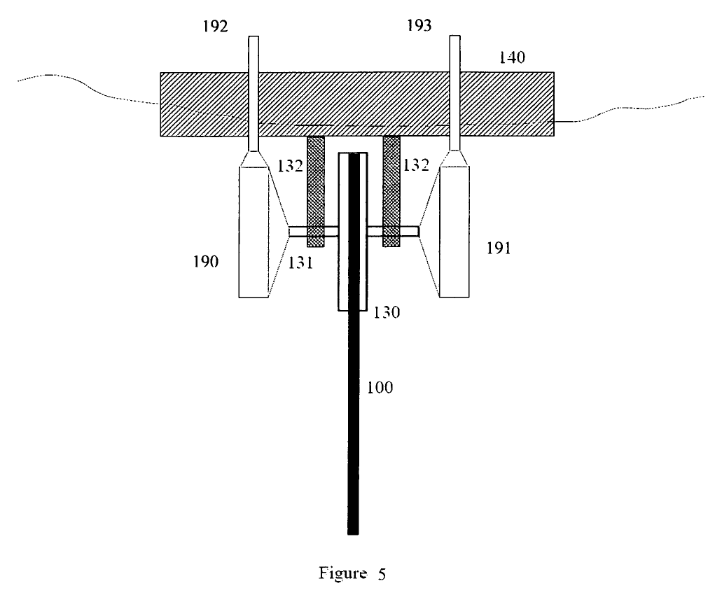

Alternatively, the pulley 130 can be connected through various mechanisms to a power conversion system 180 mounted on top of the float 140. FIG. 5 illustrates an embodiment of the invention which uses rotationally driven immersion pumps as part of the power conversion system. The immersion pumps can be directly mounted to the pulley axle 131. The immersion pumps allow direct power conversion with a minimum of mechanical interfaces.

As illustrated in FIG. 5, the pulley 130 is suspended on an axle 131 mounted to the float 140 by supports 132. Immersion pumps 190, 191 are also mounted below the float 140 and connected directly to the pulley axle 131. Pipes 192, 193 extend from the pumps 190, 191 through the float 140 to the upper surface. As the pulley 130 turns, with the up and down motion of the float 140, the axle 131 transmits rotational power to immersion pumps 190, 191. The immersion pumps 190, 191, in turn, pump sea water under varying pressure through pipes 192, 193. The sea water would, of course be screened at the pump intakes in order keep out debris and sea life. An alternative to pumping sea water is to use a closed system which pumps any of many possible hydraulic fluids. The liquid thus pumped through the pipes 192, 193 can, in turn, be used to drive turbines for the generation of electrical power mounted on top of the float. Alternatively, the pressurized fluid can otherwise be put to direct work in a number of ways.

A variety of immersion pump types could be employed in this design. Each has its advantages and disadvantages and changes the nature of the system in some way. In one embodiment, positive-flow pumps (that pump in the same direction independent of drive rotation) such as rotary-driven piston-ram positive-displacement or radial-flow centrifugal pumps are used. This embodiment presents several advantages. A minimum of moving parts are used in the system which limits wear and maintenance requirements. With this sort of pump, the flow through the pipes 192, 193 is always positive, both on the up and down stroke of the waves, because positive flow occurs regardless of the direction of rotation. This is advantageous over other wave generation mechanisms which either must provide rectification of the alternating power production or only produce energy on one half of the wave cycle.

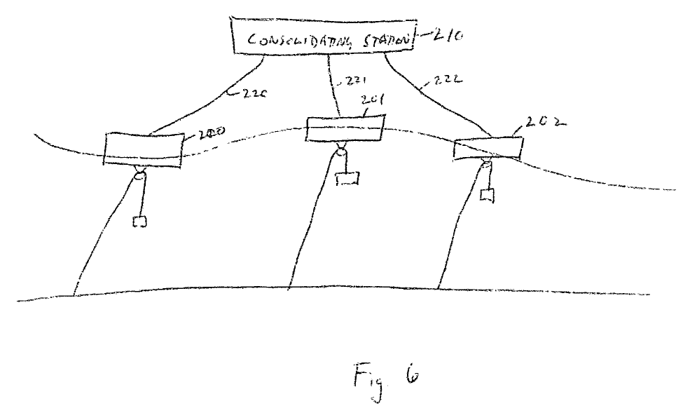

Although the hydraulic pressure produced in the pipes 192, 193 by positive-flow pumps 190, 191 is never negative it does vary in positive pressure with the wave cycle. Thus, it is advantageous to aggregate the power output of multiple implementations of the invention in a deployment, where each floating assembly moves on waves out of phase with each other. Power aggregation can be accomplished either at the hydraulic stage or after conversion to electricity. Power aggregation is discussed below in connection with FIG. 6.

The coupling between the pulley 130, axle 131 and pumps (or other energy conversion system) 190, 191 may or may not utilize gearing or other mechanical transmission means to affect (i.e. multiply) the rotational ratio between the pulley 130 and the energy conversion system 190, 191. It is generally advantageous to avoid unnecessary moving parts for reasons of wear and maintenance. The real ratio of concern is between the energy conversion system and the wave cycle. In other words, the number of rotations of the energy conversion system (i.e., pump) drive during a wave cycle to drive the energy conversion system at sufficient revolutions per minute (RPM) to be effective. In areas of large significant wave heights, this ratio may possibly be managed by choosing an appropriate ratio between the circumference of the pulley and the expected wave amplitude. If the effective RPM threshold for the energy conversion system is low, that can allow one to implement the invention with a direct coupling between the pulley and energy conversion system, minimizing moving parts. Minimizing parts decreases assembly costs and should dramatically improve the longevity of the device. Several types of positive displacement pump designs have the advantage of minimal moving parts (for durability) and excellent performance characteristics for the nature this problem domain (where the scale length and periods are set by ocean waves). In particular, some positive displacement pump designs are capable of operating efficiently at much lower drive RPMs than centrifugal pumps and most electrical generators. On the other hand, in deployments where the wave heights are not expected to be large, or the energy conversion system's effective RPM input requirements are higher, trying to accomplish a useful ratio might mean reducing the pulley to too small a diameter to be workable. A smaller pulley reduces the length of the area of engagement between the pulley 130 and the tether 100 and has a reduced mechanical advantage. If the pulley size is too small, wave motion cannot be adequately utilized. In these situations, it may be necessary to use some sort of multiplier in order to drive the pumps at a useful speed, while still providing an adequate pulley diameter.

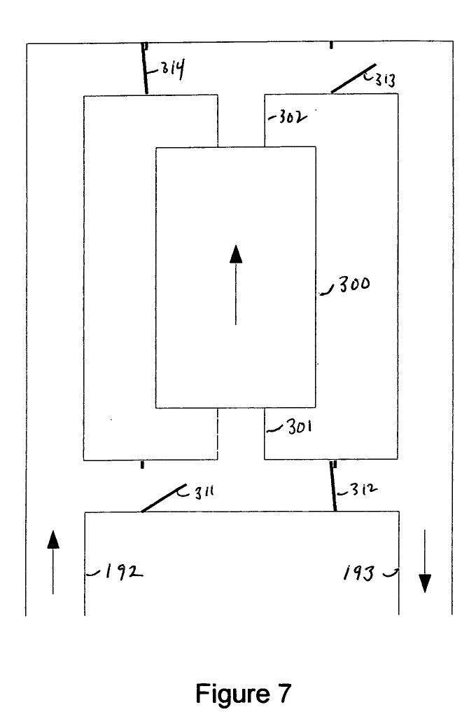

In an alternative embodiment, alternating-flow pumps such as rotary gear-type positive displacement pumps, axial-flow centrifugal pumps, or other pump types that move the fluid in alternating directions depending on the direction of rotation. By setting up the two pumps 190, 191 to be counter to each other (so that one is pumping positively while the other is pumping negatively) the two pipes 192, 193 can be connected to the input and output, respectively, of a turbine or other generator 300 (FIG. 7). As illustrated in FIG. 7, flap or check valves 311, 312, 313, 314 can be used to dynamically switch the pipe 192, 193 from each pump from input 301 to output 302 of the turbine 300, according to the positive or negative pressure at the pipe. When positive pressure is provided pipe 192 by the pump, valves 311, 313 open. Valves 312, 314 are held closed by the pressure. This causes the fluid to flow through the turbine 300 in the direction indicated by the arrow. On the other hand, when the pressure from pipe 193 is positive, valves 312, 314 will open and valves 311, 313 will close. Operation of this embodiment results in always-positive flow over the turbine.

Because the power production will be correlated with the wave motion, it would be advantageous to deploy multiple units at a site, as illustrated in FIG. 6. The multiple units 200, 201, 202 are distributed so as to be generally out of phase with each other with respect to the waves. Thus, their power contributions to a consolidating station 210 will result in more continuous output. The consolidating station 210 can be located on a barge near the floats 200, 201, 202 or on a nearby shore. The positioning of the consolidating mechanism 210 will depend upon the location of the floats relative to the shore. Consolidation can be accomplished, for example, by having the hydraulic pumps transmit hydraulic power via pipes or hoses 220, 221, 222 to the consolidating station 210 where the aggregated power contributed by all the units drives a hydraulic-to-electric generator. An additional advantage of this model is to keep the mass as small as possible at the individual floating pulley units, increasing their efficiency. Alternatively, each unit could transmit its power to the consolidating station as electrical or pneumatic power. The design must balance the efficiency of a central consolidator against potential losses during transmission from the individual floating pulley units to the consolidating station.

If the power is to be transmitted long distances to shore for usage, the transmission/conversion apparatus would likely use step-up transformers and rectifiers to convert the power to high voltage direct current for more efficient transmission via underwater power cable. By using the recommended multi-unit with consolidating mechanism deployment model, the mass of the step-up and rectification systems can be located on the consolidating station instead of on the individual floating pulley units.

Having disclosed at least one embodiment of the present invention, various adaptations, modifications, additions, and improvements will be readily apparent to those of ordinary skill in the art. For example, the invention has been described with respect to ocean waves. It can easily be used on any body of water with waves, such as lakes. Such adaptations, modifications, additions and improvements are considered part of the invention which is only limited by the several claims attached hereto.

1. A wave energy conversion system comprising:
a float positioned on a surface of a body of water having waves;
a pulley connected to the float;
a first weight; and
a tether having a first end and a second end, first end being connected to the first weight, the tether passing over and coupled to the pulley such that that the first weight moves relative to the surface of the body of water and the pulley turns as the float rises and falls with the surface of the body of water, and such that the portion of the tether between the pulley and the first weight is decoupled from and positioned away from the portion of the tether between the second end and the pulley.

2. The wave energy conversion system according to claim 1, further comprising:
a second weight heavier than the first weight attached to the second end of the tether.

3. The wave energy conversion system according to claim 1, wherein the second end of the tether is anchored to a floor of the body of water.

4. The wave energy conversion system according to claim 1, wherein the tether is dimensioned such that the first weight does not contact a floor of the body of water when the surface of the body of water at the float is at a minimum level.

5. The wave energy conversion system according to claim 1, wherein the tether is dimensioned such that the first weight does not contact the pulley when the surface of the body of water at the float is at a maximum level.

6. The wave energy conversion system according to claim 1 further comprising:
a first mooring cable having a first end attached to the float and a second end anchored to the floor of the body of water; and
a second mooring cable having a first end attached to the float and a second end anchored to the floor of the body of water.

7. The wave energy conversion system according to claim 6, wherein the second end of the first mooring cable, second end of the second mooring cable and second end of the tether are positioned relative to each other and the floor of the body of water such that the tether cannot become tangled with either of the first mooring cable and the second mooring cable.

8. The wave energy conversion system according to claim 1, further comprising:
an axle attached to the pulley; and
a power conversion system coupled to the axle to generate energy from rotation of the axle.

9. The wave energy conversion system according to claim 8, further comprising an energy collection system for transferring energy from the power conversion system to a shore of the body of water.

10. The wave energy conversion system according to claim 8, wherein the power conversion system includes an hydraulic pump.

11. The wave energy conversion system according to claim 8, wherein the power conversion system includes an electrical generator.

12. The wave energy conversion system according to claim 1, wherein the pulley is suspended below the float.

13. The wave energy conversion system according to claim 12, further comprising:
an axle attached to the pulley; and
at least one immersion pump coupled to the axle.

14. The wave energy conversion system according to claim 13, wherein the at least one immersion pump includes at least one radial-flow centrifugal pump.

15. The wave energy conversion system according to claim 13, further comprising:
a power conversion system for converting hydraulic power to electrical power; and
a pipe connecting the at least one immersion pump to the power conversion system.

16. A method for converting wave energy in a body of water to useable energy comprising the steps of:
suspending a pulley below a surface of the body of water;
coupling the pulley to a weight positioned in the body of water;
raising the weight as the surface of the body of water rises;
lowering the weight as the surface of the body of water lowers; and
turning the pulley in a first direction as the weight raises and turning the pulley in a second direction as the weight lowers.

17. The method converting wave energy in a body of water to useable energy according to claim 16, further comprising the step of deriving energy from rotation of the pulley.

18. The method converting wave energy in a body of water to useable energy according to claim 16, further comprising the step of transferring the derived energy to a shore of the body of water.

19. A system for generating energy from waves in a body of water, the system comprising:
a plurality of generating stations for generating energy, wherein each of the plurality of generating stations includes:
a tether;
a first weight positioned in the body of water having waves and coupled to one end of the tether;
a float positioned on a surface of the body of water;
a pulley suspended from the float and coupled to the tether such that the weight moves relative to the surface of the body of water and the pulley turns as the float rises and falls with the surface of the body of water; and
a collection system for collecting and combining energy from each of the plurality of generating stations.

20. The system for generating energy from waves in a body of water according to claim 19, wherein each of the plurality of generating stations includes at least one immersion pump coupled to the pulley.

21. The system for generating energy from waves in a body of water according to claim 20, further comprising a transfer system for transferring energy from the immersion pumps in each of the plurality of generating stations to a shore of the body of water.

22. The system for generating energy from waves in a body of water according to claim 21, wherein the transfer system includes:
a collection system positioned on the body of water that combines energy from the plurality of generating stations.
